(19) United States
(12) Patent Application Publication
(10) Pub. No.: US 2005/0239511 A1
(43) Pub. Date: Oct. 27, 2005

(54) Speaker identification using a mobile communications device

(75) Inventors: Marc A. Boillot, Plantation, FL (US); Charles D. Estes, Fort Lauderdale, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/829,899

(22) Filed: Apr. 22, 2004

(51) Int. Cl. H04B 1/38

(52) U.S. Cl. 455/563

(57) ABSTRACT

A method (200) of voice identification within a mobile communication device can include detecting a voice signal within the mobile communication device (225) and determining at least one voice feature of the voice signal (230). At least one of the voice features of the voice signal can be compared with voice profiles accessible by the mobile communication device (235). Each voice profile also can be associated with an identity. Accordingly, at least one of the voice features of the voice signal can be matched with one of the voice profiles (240) and the identity associated with the matched voice profile can be presented through the mobile communication device (255).

### BACKGROUND

1. Field of the Invention

The present invention relates to the field of voice or speaker identification, and more particularly to identification using a mobile communications device.

2. Description of the Related Art

For many professionals, networking is an important aspect of career development and business success. Networking events provide forums within which professionals can meet, discover common business interests, share personal experiences, and the like. Typically, such interaction begins or ends with the exchange of business cards. After a networking event, collected business cards can be cataloged using a contact management tool or system. Alternatively, one can simply attempt to commit new contacts to memory.

To effectively network, it is imperative that professionals remember the names and other identifying information relating to contacts met during prior networking events. Recalling such information can be difficult in light of the large number of contacts one may encounter and the large number of networking events one may attend. Relying upon memory alone often is not a reliable means of recalling contact information.

Proposed solutions for recalling identifying information for contacts have included using a personal digital assistant (PDA) or a business card folio. Unfortunately, the very act of accessing a PDA or perusing business cards can send a signal to a contact that they were not remembered and, therefore, not considered important.

Another proposed solution involving PDA's has been the automatic exchange of electronic business cards between such devices via a wireless communication link. This solution, however, also suffers from disadvantages. In particular, the parties that wish to exchange information must have capable and compatible PDA's. Additionally, as described above, the very act of accessing a one's PDA serves as an indication that the identity of the contact was not remembered, thereby causing a potentially embarrassing situation. No existing device discretely and automatically provides a way in which persons can access identifying information for contacts.

### SUMMARY OF THE INVENTION

The present invention provides a method, system, and apparatus for determining an identity for a detected voice. In accordance with the inventive arrangements disclosed herein, a mobile communications device can detect a voice signal from a conversation conducted proximate to the device or from an established mobile telephone call. The voice signal can be analyzed to determine various voice features which then can be compared with stored voice profiles. The user of the mobile communications device can be notified of a matched identity when such a match is determined.

One embodiment of the present invention can include a method of voice identification within a mobile communication device. The method can include detecting a voice signal with the mobile communication device and determining at least one voice feature of the voice signal. One or more of the voice features of the voice signal can be compared with voice profiles accessible by the mobile communication device. Each of the voice profiles can be associated with an identity. One or more voice features of the voice signal can be matched with one of the voice profiles. Accordingly, the identity associated with the matched voice profile can be presented.

Other embodiments of the present invention can include a machine readable storage programmed to cause the mobile communication device to perform the various steps disclosed herein as well as a system having means for performing the steps disclosed herein.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a voice processing system for use within a mobile communication device in accordance with one embodiment of the present invention.

FIG. 2 is a flow chart illustrating a method of determining an identity for a received voice signal in accordance with another embodiment of the present invention.

### DETAILED DESCRIPTION OF THE INVENTION

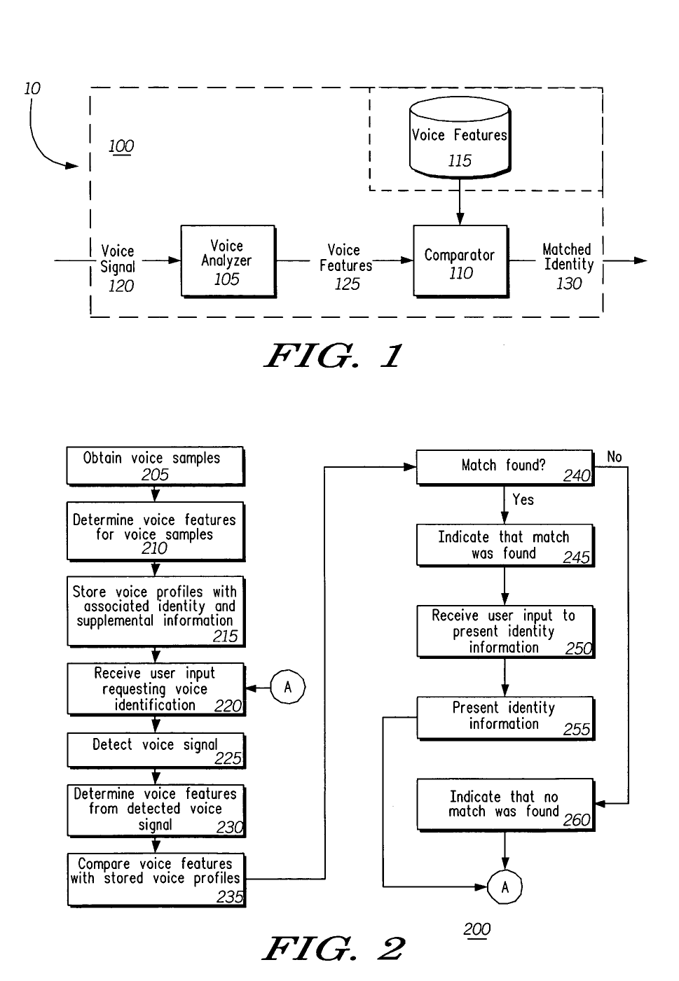

FIG. 1 is a schematic diagram illustrating a voice processing system 100 for use with a mobile communication device (mobile device) 10 in accordance with one embodiment of the present invention. The voice processing system 100 can be disposed within a mobile device such as a wireless device capable of transmitting and receiving voice communications and/or text messages. According to one embodiment of the present invention, such a mobile device can be implemented as a mobile telephone having a receiver, transmitter, or alternatively a transceiver, an audio system, a display screen, a battery or power source, and the like. Accordingly, the voice processing system 100 can be communicatively linked with the various systems and components of such a mobile device.

As shown in FIG. 1, the voice processing system 100 can include a voice analyzer 105, a comparator 110, and a data store 115. The voice analyzer 105 can receive a digitized voice signal 120 and determine or extract one or more voice features 125 from the voice signal 120. More particularly, the voice analyzer 105 can determine those features of the voice signal 120 which allow the voice signal 120 to be uniquely identified. Examples of such voice features can include, but are not limited to, spectral envelope, pitch information such as pitch inflection, prosody, and word rate of the voice signal.

The voice features 125 extracted or identified from the digitized voice signal 120 can be provided to a comparator 110. The comparator 110, having access to a data store 115 of voice profiles, each specifying one or more voice features, can compare received voice features 125 with the stored voice profiles to determine a match. Note, the comparator 110 or a “match” does not necessarily need to be 100% accurate. If desired, the comparator 110 can output a certainty figure with a matched identity 130 to enable the voice processing system 100 to identify a target match within a predetermined threshold percentage such as with 80% certainty.

The data store 115 can be memory, or a portion of memory, that includes one or more voice profiles. Note, the data store can include either local memory within the mobile device or remote memory or both. The remote memory can be accessible via a network such as a wireless network. Each voice profile, or entry, can be associated with an identity or name. Notably, the identity or name can be stored as text or as an audio recording. According to another embodiment of the present invention, each voice profile within data store 115 also can be associated with supplemental information. Supplemental information can include, but is not limited to, a physical address, electronic mail address, textual data, telephone number, mobile telephone number, picture, video, or the like. Accordingly, the data store 115 can include one or more voice profiles, each being associated with an identity and optional supplemental information relating to the identity.

The comparator 110 can compare the received voice features 125 with the voice profiles stored in data store 115. From the comparison, a voice profile that matches the voice features 125 can be found. The associated matched identity 130 of the matched voice profile can be determined and made available to the user of the mobile device 100 within which the voice processing system 100 is disposed.

The various components of voice processing system 100 can be implemented as one or more software modules executing within one or more suitable processors, as a collection of one or more dedicated hardware modules, or a combination thereof. For example, according to one embodiment, the voice analyzer 105 and comparator 110 can be implemented as software components executed by a digital signal processor. In another embodiment, the voice processing system 100 can be implemented as a collection of one or more application specific integrated circuits or programmable logic devices.

FIG. 2 is a flow chart illustrating a method 200 of determining an identity for a received voice signal using a mobile device in accordance with another embodiment of the present invention. The mobile device can include the voice processing system of FIG. 1.

As shown, the method 200 can begin in step 205 where one or more voice samples or digitized recordings of voices can be obtained. The recordings can be obtained through an internal microphone of the mobile device, for example by recording a voice of a person proximate to the mobile device that is engaged in a conversation, from an ongoing mobile telephone call, for example by detecting the voice of a call participant received via a mobile communication link, or by uploading voice samples from a computer system or other data store.

In step 210, one or more voice features can be determined for each of the voice samples. In step 215, each set of voice features corresponding to a particular voice sample can be stored as a voice profile and associated with a name or identity as well as optional supplemental information also relating to the identity. The information can be stored in a data store of the mobile device or alternatively in a remote data store. Thus, through a suitable mobile device interface, a mobile device user can program the mobile device with voice profiles specifying voice features of different persons to be recognized at a future time, an associated identity or name, and associated supplemental information.

In step 220, a user input requesting voice identification can be received by the mobile device. For example, a user of the mobile device can activate a button, switch, or control on the mobile device to engage or initiate the voice identification functionality described herein. The activation of such a control allows a user of a mobile device, such as a mobile telephone, to discretely engage voice identification functionality. For example, such function can be activated or initiated automatically by detecting a predetermined sound level.

In step 225, the mobile device can detect a voice signal. In one embodiment of the present invention, the voice signal can be detected via an internal transducer, such as a microphone of the mobile device, if not engaged in a mobile telephone call. In that case, a voice from another person that is proximate to the mobile device and engaged in conversation can be detected. Thus, the voice can be converted to an analog signal by the transducer and then converted to a digital signal for further processing.

In another embodiment, for example in the case where the mobile device is engaged in an established mobile telephone call, the voice signal can be detected from the established mobile telephone call. More particularly, any audio signals received via a mobile communication link, specifically voice signals associated with non-users of the mobile device that are participating in the call, can be detected and processed.

In step 230, voice features can be determined or extracted from the detected voice signal, whether the voice signal was received via the transducer of the mobile device or as a mobile communication. In step 235, the voice features of the detected voice signal can be compared with voice profiles stored in the mobile device. That is, voice features of a detected voice, one that is to be identified, are compared with voice features stored within the mobile device so that a match can be determined.

In step 240, a determination can be made as to whether a match was found. As previously mentioned above, a “match” does not necessarily require 100% accuracy. In this regard, a match includes a “substantial match” or a matching step includes the step of substantially matching. If so, the method can proceed to step 245. If not, however, the method can proceed to step 260.

Continuing with step 245, the mobile device can indicate that a match was found. In one embodiment, the indication can be a ringing tone or sound as if the mobile device were receiving a mobile telephone call or other mobile communication. In another embodiment, the mobile device can begin to vibrate to provide the indication. In yet another embodiment, the mobile device can provide a visual indication that a match was found such as illuminating a light or light emitting diode or displaying a message on a display screen of the mobile device. In any event, it should be appreciated that the indication that a match was found can be discrete in that the indication can simulate an indication of a conventional mobile communication such as a telephone call, a text message, an electronic mail message, a page, a facsimile, or the like.

In step 250, the mobile device can receive a user input requesting that the matched identifying information be presented. Although the user input can be any of a variety of actions, such as the manipulation of a switch or button, in one embodiment the user input can be the action ordinarily taken to answer a telephone call or other incoming mobile communication. For example, in the case of a so called “clamshell” mobile phone, the user input can be the action of opening the phone, or pressing a button once the phone has been opened. In the case of a conventional mobile phone, the user input can be the activation of a button to answer the incoming simulated mobile communication.

Thus, if the user of the mobile device is engaged in a conversation, the user can interrupt the conversation to act as if answering an incoming communication to receive identifying information for the conversation participant. If the user of the mobile device is engaged in an established mobile telephone call, the user can place the existing call on hold and act as if answering an incoming mobile communication to receive identifying information for the call participant. Such a feature can be useful in the case where caller ID information is not available for an incoming call.

In step 255, the identity associated with the matched voice features, or voice profile, can be presented. In one embodiment of the present invention, the identity can be audibly presented or played through the audio system of the mobile device or a peripheral device such as an earpiece as a conventional mobile telephone call. This would enable the user of the mobile device to answer the indication or ringing mobile device and hear, in a discrete manner, an audible representation of the identity associated with the matched voice profile.

Notably, the audio representation can be provided via a text-to-speech system in the event the mobile device is equipped with such a feature. Alternatively, the audio representation can be provided by playing back a digital recording of the identity or name. Such a digital recording can be made, for example, at the time the mobile device was programmed with voice features corresponding to the matched identity. Still, it should be appreciated that the identity can be presented visually, for example via the display screen of the device as a text message or in another format.

It should be appreciated that any supplemental information associated with the matched voice profile also can be presented. Such information can be presented following the identity, or can be presented responsive to a further user input requesting the supplemental information.

After step 255, the method can continue to jump to circle A to repeat as necessary.

In the case where no match was determined for a received voice signal, the method can proceed from step 240 to step 260. In step 260, an indication that no match was found can be provided. The indication can be a special sound signal, vibration, visual message, or the like that specifies that no match was found. Again, the method can continue to jump circle A to repeat as may be required.

The method 200, as described herein, has been provided for purposes of illustration only. As such, the examples and illustrations disclosed herein are not intended as a limitation of the present invention. For example, in an alternative embodiment, when a match is determined for a detected voice, the manner in which the identity and/or supplemental information is presented can depend upon the way in which the data is stored. That is, if textual identity information is stored and matched to a received voice signal, then a visual message specifying the determined identity and/or supplemental information can be presented. If, however, audio identity information is stored and matched to a received voice signal, then the identity and/or supplemental information can be audibly presented. Thus, the mobile communications device can determine the manner in which the identity and/or supplemental information is to be presented based upon the type, text or audio, of identity information that is stored. Still, a user can configure the mobile device to use one delivery mechanism or another as a user preference.

The present invention can be realized in hardware, software, or a combination of hardware and software. Any kind of computer system or other apparatus adapted for carrying out the methods described herein is suited. A typical combination of hardware and software can be a mobile communication device, such as a mobile telephone, with a computer program that, when being loaded and executed, controls the mobile device such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. Within a mobile communication device, a method of voice identification comprising:
detecting a voice signal within the mobile communication device;
determining at least one voice feature of the voice signal;
comparing the at least one voice feature of the voice signal with voice profiles accessible by the mobile communication device, wherein each voice profile is associated with an identity;
matching the at least one voice feature of the voice signal with one of the voice profiles; and
presenting the identity associated with the matched voice profile via the mobile communication device.

2. The method of claim 1, further comprising:
first receiving a user input, within the mobile communication device, requesting voice identification.

3. The method of claim 1, further comprising:
prior to said presenting step, indicating that a match was determined; and
receiving a user input instructing the mobile communication device to present the matched identity.

4. The method of claim 3, said indicating step comprising:
playing an audible notification or vibrating.

5. The method of claim 3, said indicating step comprising:
visually indicating that a match was determined.

6. The method of claim 3, said presenting step further comprising:
playing an audible representation of the matched identity.

7. The method of claim 3, said presenting step further comprising:
displaying a visual representation of the matched identity.

8. The method of claim 3, further comprising:
identifying supplemental information associated with the matched identity; and
playing an audible representation of the supplemental information.

9. The method of claim 3, further comprising:
identifying supplemental information associated with the matched identity; and
displaying a visual representation of the supplemental information.

10. The method of claim 1, said presenting step further comprising:
determining whether the identity is stored as audio information or textual information; and
selectively presenting the identity by playing the audio information or displaying the textual information according to said determining step.

11. The method of claim 1, said detecting step comprising obtaining the voice signal from a participant of an established mobile telephone call conducted with the mobile communication device, wherein the participant is not a user of the mobile communication device.

12. The method of claim 1, said detecting step comprising receiving the voice signal from a person proximate to the mobile communication device, wherein the voice signal is not part of an established mobile telephone call.

13. A mobile communication device configured for voice identification comprising:
means for detecting a voice signal within the mobile communication device;
means for determining at least one voice feature of the voice signal;
means for comparing the at least one voice feature of the voice signal with voice profiles accessible by the mobile communication device, wherein each voice profile is associated with an identity;
means for matching the at least one voice feature of the voice signal with one of the voice profiles; and
means for presenting the identity associated with the matched voice profile via the mobile communication device.

14. The system of claim 13, further comprising:
means for first receiving a user input, within the mobile communication device, requesting voice identification.

15. The system of claim 13, further comprising:
means for indicating that a match was determined, said means for indicating being operable prior to said means for presenting; and
means for receiving a user input instructing the mobile communication device to present the matched identity.

16. The system of claim 15, said means for presenting further comprising:
means for displaying a visual representation of the matched identity.

17. The system of claim 15, further comprising:
means for identifying supplemental information associated with the matched identity; and
means for playing an audible representation of the supplemental information.

18. The system of claim 15, further comprising:
means for identifying supplemental information associated with the matched identity; and
means for displaying a visual representation of the supplemental information.

19. The system of claim 13, said means for presenting further comprising:
means for determining whether the identity is stored as audio information or textual information; and
means for selectively presenting the identity by playing the audio information or displaying the textual information according to a determination made by said means for determining.

20. The system of claim 13, said means for detecting comprising means for obtaining the voice signal from a participant of an established mobile telephone call conducted with the mobile communication device, wherein the participant is not a user of the mobile communication device.

21. The system of claim 13, said means for detecting comprising means for receiving the voice signal from a person proximate to the mobile communication device, wherein the voice signal is not part of an established mobile telephone call.

22. A machine readable storage, having stored thereon a computer program having a plurality of code sections executable by a mobile communication device for causing the device to perform the steps of:
detecting a voice signal within the mobile communication device;
determining at least one voice feature of the voice signal;
comparing the at least one voice feature of the voice signal with voice profiles stored within the mobile communication device, wherein each voice profile is associated with an identity;
matching the at least one voice feature of the voice signal with one of the voice profiles; and
presenting the identity associated with the matched voice profile via the mobile communication device.
